(19) United States
(12) Patent Application Publication
(10) Pub. No.: US 2011/0104604 A1
(43) Pub. Date: May 5, 2011

(54) TONER AND MANUFACTURING METHOD OF TONER

(75) Inventors: Kenji HAYASHI, Tokyo (JP); Hiroaki OBATA, Tokyo (JP); Yukio HOSOYA, Tokyo (JP); Kouji SHIBATA, Tokyo (JP); Mikio KOUYAMA, Tokyo (JP)

(73) Assignee: KONICA MINOLTA BUSINESS TECHNOLOGIES, INC., Tokyo (JP)

(21) Appl. No.: 12/916,997

(22) Filed: Nov. 1, 2010

(30) Foreign Application Priority Data
Nov. 4, 2009 (JP) 2009-252938

(51) Int. Cl. G03G 9/08

(52) U.S. Cl. 430/108.1; 430/137.14

(57) ABSTRACT

Disclosed is a manufacturing method of a toner including a vinyl series resin being a polymer of a radical polymerizable monomer, and a coloring agent, the method comprising: dispersing a crystalline organic compound having an unsaturated bond in an aqueous medium to prepare a dispersion liquid of the crystalline organic compound; causing a radical polymerization reaction between an unsaturated bond part of the crystalline organic compound and the radical polymerizable monomer after adding the radical polymerizable monomer to the dispersion liquid of the crystalline organic compound, to prepare a dispersion liquid of resin particles including the obtained polymer; and mixing at least the dispersion liquid of the resin particles and a dispersion liquid of coloring agent particles, and aggregating the resin particles and the coloring agent particles to form toner particles.

### CROSS-REFERENCE TO RELATED APPLICATION

The present U.S. patent application claims a priority under the Paris Convention of Japanese patent application No. 2009-252938 filed on Nov. 4, 2009, which shall be a basis of correction of an incorrect translation.

### BACKGROUND OF THE INVENTION

1. Field of the Invention

The present invention relates to a toner and a toner manufacturing method.

2. Description of the Related Art

A printer, or the like, adopting an electrophotographic printing system has been asked to save energy, and the demand of a toner having the so-called low temperature fixability capable of being fixed at a low temperature has increased.

In order to realize the low temperature fixability, it has been performed to lower the glass transition point (Tg) of a resin. Setting the glass transition point to be low, however, makes the toner be easily influenced by the environment at the time of keeping the toner, and consequently causes a problem in the blocking tendency of the toner, generating mutual fusion of the particles of the toner. As disclosed, for example, in Japanese Patent Application Laid-Open Publication No. 2006-267732, it has accordingly been performed to use resin particles including a polycondensation type crystalline polyester, which exhibits a sharp melting behavior against temperature, as a binding resin constituting a toner.

Even if composite particles of a crystalline organic compound, represented by the crystalline polyester, and a vinyl series resin can stably be produced, however, the crystalline organic compound is led to dissolve in the process of producing a toner using the composite resin particles like this through a heating process of performing the aggregation and the fusion of the composite resin particles in an aqueous medium. Consequently, it is difficult to make the crystalline organic compound exist in the state of being incompatible with a main resin, or to avoid the exposure onto toner surfaces. Thus, the performance to be essentially expected for the crystalline organic compound cannot be revealed at the time of being produced as a toner, and it has been impossible for the composite particles to exhibit sufficient blocking resistance while keeping the low temperature fixability sufficiently.

### SUMMARY OF THE INVENTION

The present invention was made in view of the aforesaid circumstances, and aims to provide a toner, having superior low temperature fixability and blocking resistance (heat storage resistance), the toner having the property of suppressing the exposure of a crystalline organic compound to the surfaces of the toner, the toner capable of preventing external additive embedding, carrier contamination, and the like, the toner having the property of stabilizing a charge quantity over a long time, and a manufacturing method of the toner.

To achieve at least one of the abovementioned objects, a manufacturing method of a toner including a vinyl series resin being a polymer of a radical polymerizable monomer, and a coloring agent, reflecting one aspect of the present invention comprises:

dispersing a crystalline organic compound having an unsaturated bond in an aqueous medium to prepare a dispersion liquid of the crystalline organic compound;

causing a radical polymerization reaction between an unsaturated bond part of the crystalline organic compound and the radical polymerizable monomer after adding the radical polymerizable monomer to the dispersion liquid of the crystalline organic compound, to prepare a dispersion liquid of resin particles including the obtained polymer; and

mixing at least the dispersion liquid of the resin particles and a dispersion liquid of coloring agent particles, and aggregating the resin particles and the coloring agent particles to form toner particles.

To achieve at least one of the abovementioned objects, a toner including a vinyl series resin being a polymer of a radical polymerizable monomer, and a coloring agent, reflecting another aspect of the present invention comprises:

a crystalline organic compound, the crystalline organic compound having an unsaturated bond, wherein

a radical polymerization reaction is caused between an unsaturated bond part of the crystalline organic compound and the radical polymerizable monomer.

### BRIEF DESCRIPTION OF THE DRAWINGS

The present invention will become more fully understood from the detailed description given hereinbelow and the appended drawings, and thus are not intended as a definition of the limits of the present invention, wherein;

FIG. 1 shows Table 1;

FIG. 2 shows Table 2; and

FIG. 3 shows Table 3.

### DETAILED DESCRIPTION OF THE PREFERRED EMBODIMENTS

In the following, a toner and a manufacturing method of the toner according to the present invention will be described.

The toner according to the embodiment of the present invention, including a vinyl series resin being a polymer of a radical polymerizable monomer, and a coloring agent, comprises:

a crystalline organic compound, the crystalline organic compound having an unsaturated bond, wherein a radical polymerization reaction is caused between an unsaturated bond part of the crystalline organic compound and the radical polymerizable monomer.

Further, the toner according to the embodiment of the present invention, including a vinyl series resin being a polymer of a radical polymerizable monomer, and a coloring agent, may be manufactured by the method comprising:

dispersing a crystalline organic compound having an unsaturated bond in an aqueous medium to prepare a dispersion liquid of the crystalline organic compound;

causing a radical polymerization reaction between an unsaturated bond part of the crystalline organic compound and the radical polymerizable monomer after adding the radical polymerizable monomer to the dispersion liquid of the crystalline organic compound, to prepare a dispersion liquid of resin particles including the obtained polymer; and

mixing at least the dispersion liquid of the resin particles and a dispersion liquid of coloring agent particles, and aggregating the resin particles and the coloring agent particles to form toner particles.

For manufacturing a toner, a releasing agent, an external additive, and the like, are used as the occasion demands besides a crystalline organic compound including an unsaturated bond and a coloring agent. A toner particle may have a core shell structure comprising a core layer and a shell layer covering the core layer.

### <Crystalline Organic Compound Having Unsaturated Bond>

The crystalline organic compound according to the present invention indicates an organic compound having a distinct heat absorption peak, not stepwise heat absorption changes, in differential scanning calorimetry (DSC). The distinct heat absorption peak specifically means a heat absorption peak having a half-value width of 15° C. or lower at the time of the measurement by the differential scanning calorimetry (DSC) under the condition in which the temperature rises by the speed of 10° C./min. As such, crystalline polyester resin, a crystalline ester compound, and the like, can specifically be given. The crystalline polyester resin is especially preferable among them.

The unsaturated bond means a chemical bond bonding with two or more values between adjacent atoms, and an crystalline organic compound having an unsaturated bond in its molecule is referred to as a crystalline organic compound having an unsaturated bond.

A radical polymerization reaction of an unsaturated bond part and a radical polymerizable monomer results in forming a molecule in which a unit of the crystalline organic compound and a unit of the radical polymerizable monomer exist. That is, a hybrid resin in which different kinds of resins are bonded together with chemical bonds is formed.

The melting point of the crystalline organic compound is preferably within a range of 40-100° C. from the point of view of low temperature fixability. Furthermore, the number average molecular weight of the crystalline organic compound is preferably within a range of 500-10000.

### <Crystalline Polyester Resin>

The crystalline polyester resin according to the present invention has only to be a polyester resin having crystallinity, which polyester resin can be obtained by a condensation polymerization reaction between a publicly known two or more value (polyvalent) carboxylic acid and a publicly known two or more values (polyvalent) alcohol.

The two or more value polycarboxylic acid is a compound including two or more carboxyl groups in one molecule thereof. For example, saturated aliphatic dicarboxylic acids, such as oxalic acid, malonic acid, succinic acid, adipic acid, sebacic acid, azelaic acid, and n-dodecyl succinic acid; alicyclic dicarboxylic acids, such as cyclohexanedicarboxylic acid; aromatic dicarboxylic acids, such as phthalic acid, isophthalic acid, and terephthalic; three or more value polycarboxylic acids, such as trimellitic acid and pyromellitic acid; anhydrides of these carboxylic acids; and alkyl (carbon number: 1-3) esters of the carboxylic acids can be given. One kind of these compounds may be used solely, or two or more kinds of them may be used by being combined with each other.

Each of the two or more value polyvalent alcohols is a compound including two or more hydroxyl groups in one molecule. For example, aliphatic dials, such as 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol; three or more value polyvalent alcohols, such as glycerol, pentaerythritol, trimethylolpropane, and sorbitol; and the like, can be given. Two or more kinds of these alcohol components may be used in the state of being combined with each other.

The crystalline polyester resin having an unsaturated bond can be obtained by using an unsaturated polycarboxylic acid or an unsaturated polyvalent alcohol among polycarboxylic acids or polyvalent alcohols to be used for a condensation polymerization reaction. As the unsaturated polycarboxylic acids, fumaric acid, maleic acid, itaconic acid, mesaconic acid, citraconic acid, and glutaconic acid can be given. As the unsaturated polyvalent alcohols, alkene dials, such as butenediol, can be given.

The unsaturated polycarboxylic acid is preferably made to be included by the amount of 1-20 mol % of the whole quantity of the polycarboxylic acid to be used for producing the polyester resin.

The unsaturated polyvalent alcohol is preferably made to be included by the amount of 1-20 mo % of the whole quantity of the polyvalent alcohol to be used for producing the polyester resin.

### <Crystalline Ester Compound>

The crystalline ester compound according to the present invention may be any ester compound produced by a publicly known acid and a publicly known alcohol as long as the ester compound has crystallinity.

As the acid, saturated fatty acids, such as acetic acid, propionic acid, butyric acid, isobutyric acid, valeric acid, 3-methylbutanoic acid, 2-methylbutyric acid, pivalic acid, hexanoic acid, 4-methylvaleric acid, 2-ethylbutyric acid, 2,2-dimethylbutyric acid, heptanoic acid, octanoic acid, nonanoic acid, decanoic acid, undecanoic acid, lauric acid, tridecanoic acid, myristic acid, pentadecylic acid, palmitic acid, heptadecanoic acid, stearic acid, nonadecanoic acid, eicosanoic acid, behenic acid, tricosanoic acid, and lignoceric acid; and aliphatic dicarboxylic acids, such as oxalic acid, malonic acid, succinic acid, glutaric acid, adipic acid, pimelic acid, suberic acid, azelaic acid, and sebacic acid are given. The saturated fatty acids are preferable among these carboxylic acid compounds. As the saturated fatty acids, saturated fatty acids of the carbon numbers of 10-30 are preferable; those of 12-26 are more preferable; those of 14-25 are further more preferable; and those of 18-24 are particularly preferable.

As the alcohols, linear or branched alcohols of carbon numbers 10-40 or preferably 12-30 may be adopted. As the linear alcohols, for example, decanol, undecanol, dodecanol, tridecanol, tetradecanol, pentadacanol, hexadecanol, heptadecanol, octadecanol, nonadecanol, eicosanol, heneicosanol, docosanol, tricosanol, tetracosanol, hexacosanol, octacosanol, and triacontanol can be given.

As the polyvalent alcohols, glycerol, pentaerythritol, and the like, can be given.

The ester compound having an unsaturated bond can be obtained by using a carboxylic acid having an unsaturated bond or the like among the acids to be used for an ester reaction.

As the carboxylic acid having an unsaturated bond, unsaturated fatty acids, such as oleic acid, elaidic acid, erucic acid, brassidic acid, sorbic acid, linolic acid, linolenic acid, and arachidonic acid; and unsaturated dicarboxylic acids, such as fumaric acid, maleic acid, itaconic acid, mesaconic acid, citraconic acid, and glutaconic acid can be given. The carboxylic acid having an unsaturated bond is preferably made to be included by 1-20 mol of the whole quantity of the carboxylic acid to be used for ester compound producing.

In the present invention, the crystalline organic compound having an unsaturated bond and the radical polymerizable monomer are made to perform a radical polymerization reaction.

### <Radical Polymerizable Monomer>

As the polymerizable monomers, vinyl monomers, for example, methacrylic acid ester derivatives, such as styrene, methyl methacrylate, ethyl methacrylate, n-butyl methacrylate, isopropyl methacrylate, isobutyl methacrylate, t-butyl methacrylate, n-octyl methacrylate, 2-etylhexyl methacrylate, stearyl methacrylate, lauryl methacrylate, phenyl methacrylate, diethylaminoethyl methacrylate, and dimethylaminoethyl methacrylate; acrylic ester derivatives, such as methyl acrylate, ethyl acrylate, isopropyl acrylate, n-butyl acrylate, t-butyl acrylate, isobutyl acrylate, n-octyl acrylate, 2-etylhexyl acrylate, stearyl acrylate, lauryl acrylate, and phenyl acrylate; olefines, such as ethylene, propylene, and isobutylene; and acrylic acid or methacrylic acid derivatives, such as acrylonitrile, methacrylonitrile, and acrylamide can be given. One of these vinyl monomers can separately be used, or two or more of them can be used in combination with each other.

As the polymerizable monomer, styrene, butyl acrylate, 2-ethylhexyl acrylate, methyl methacrylate, methacrylic acids, and acrylic acids are preferably used among the aforesaid polymerizable monomers. The styrene, the butyl acrylate, and the 2-ethylhexyl acrylate are hydrophobic monomers, and consequently these polymerizable monomers have the advantage that it is easy to adjust the electrification characteristic and the glass transition point of a toner by means of the combination of the monomers. Furthermore, the methacrylic acids and the acrylic acids are hydrophilic monomers, and have the advantages that the dispersion stability of a dispersion liquid of resin particles including polyester resin particles is improved and that the aggregated diameter (the size of aggregated particles) of the resin particles can easily be controlled.

A polymerizable monomer containing an acrylic acid or a methacrylic acid has an electrically-charged dissociative functional group, such as a carboxyl group. It can be considered that, by causing the radical polymerization of a polyester resin with such polymerizable monomers, the dissociative functional groups are oriented on the surfaces of the polyester resin particles, and that repulsive electric charges are produced between the polyester resin particles to improve the dispersion stability of the particles. By the improvement of the dispersion stability, the aggregation speed of the polyester resin particles becomes slower, and the particle diameters and the forms of aggregated particles are led to be easily controlled. As a result, even when a polyester resin is used in order to realize low temperature fixation, the particle size distribution of the toner can be made to be sharp, and the form of each particles can also be formed almost in a sphere, thus enabling to prevent the defect of transferred colorant.

### <Coloring Agent>

As the coloring agent, publicly known coloring agents, such as carbon blacks, magnetic substances, dyes, and pigments, can arbitrarily be used.

As a black coloring agent, magnetic powder of magnetite, ferrite, and the like, can be used besides carbon blacks, such as furnace black and channel black.

As a color coloring agent, pigments, such as C. I. pigment red 5, same 48:1, same 53:1, same 57:1, same 81:4, same 122, same 139, same 144, same 149, same 166, same 177, same 178, same 222, C. I. pigment yellow 14, same 17, same 74, same 93, same 94, same 138, same 155, same 180, same 185, C. I. pigment orange 31, same 43, C. I. pigment blue 15:3, same 60, and same 76 can be given. Furthermore, dyes, such as C. I. solvent red 1, same 49, same 52, same 58, same 68, same 11, same 122, C. I. solvent yellow 19, same 44, same 77, same 79, same 81, same 82, same 93, same 98, same 103, same 104, same 112, same 162, C. I. solvent blue 25, same 36, same 69, same 70, same 93, and same 95 can be given. Furthermore, these pigments and dyes may be mixed together.

### <Releasing Agent>

As the releasing agent, for example, branched chain hydrocarbon waxes, such as polyolefin waxes including polyethylene wax, polypropylene wax, and the like, and microcrystalline wax; long chain hydrocarbon series waxes, such as paraffin wax, and sasol wax; dialkyl ketone series waxes, such as distearyl ketone; ester series waxes, such as carnauba wax, montan wax, behenic acid behenate, trimethylolpropane tribehenate, pentaerythritol tetrabehenate, pentaerythritol diacetate dibehenate, glycerol tribehenate, 1,18-octadecane diol distearate, trimellitic acid tristearyl, and distearyl maleate; and amide series waxes, such as ethylene diamine behenyl amide and trimellitic acid tristearyl amide can be given.

As the additive amount of the releasing agent to a toner, 1-30 mass % is preferable.

It is preferable from the point of view of a filming resistance property to use cerium oxide particles, titanate particles, a fatty acid of a carbon number of 20-50, or higher alcohol particles in conjunction with publicly known hydrophobic silica or a publicly known hydrophobic metal oxide as the external additive. If the cerium oxide particles or the titanate particles are added, it is preferable from the point of view of enhancing the filming resistance property to use the external additive having a number mean particle diameter of 150-800 nm.

### <Manufacturing Method of Toner>

In the following, a manufacturing method of the present invention will be described by using concrete examples.

(1) The process of dispersing an crystalline organic compound having an unsaturated bond into an aqueous medium to prepare a dispersion liquid of the crystalline organic compound

A crystalline organic compound having an unsaturated bond may be dissolved in a solvent of an ethyl acetate or the like, and the crystalline organic compound may be dispersed by emulsification in the aqueous medium with a disperser before performing desolvation processing. Alternatively, the crystalline organic compound may be dispersed at a temperature of 120° C. or higher without using any solvents. Alternatively, as shown in Japanese Patent Application Laid-Open Publication No. 2006-337995, a dispersion liquid of a crystalline organic compound may be produced by forming droplets of a polyvalent alcohol and a polycarboxylic acid together with a dodecyl benzenesulfonic acid in an aqueous medium, followed by condensing the droplets.

(2) The process of adding a radical polymerizable monomer to the dispersion liquid of the crystalline organic compound, and then causing a radical polymerization reaction between the unsaturated bond part of the crystalline organic compound and the radical polymerizable monomer to prepare a dispersion liquid of the resin particles including the obtained polymer

A radical polymerizable monomer and a polymerization initiator are added to the dispersion liquid of the crystalline organic compound of the process (1) to prepare a dispersion liquid of resin particles including the resin made of a polymer of the crystalline organic compound and the polymerizable monomer. At this time, a chain transfer agent may be added in order to adjust the molecular weight of the polymer. The polymerizable monomer may preferably be added to the crystalline organic compound by a mass ratio of 5-70%. Furthermore, the resin particles in the dispersion liquid prepared at this process preferably have a median diameter of 50-300 nm on the volumetric basis.

The resin particles in the dispersion liquid prepared at this process preferably include crystalline organic compound particles as nuclei covered by a vinyl series resin, which is to be a polymer of the radical polymerizable monomer, thereon.

In a case of adding a releasing agent, a dispersion liquid of releasing agent particles is added at this process, and a dispersion liquid of the resin particles and the releasing agent particles is prepared in advance, and then the dispersion liquid can be aggregated at a process (4).

Alternatively, it is also possible to add a dispersion liquid (wax emulsion) of releasing agent particles and to salt out and aggregate the resin particles, the coloring agent particles, and the releasing agent particles at the process (4).

As the polymerization initiator, any polymerization initiator may suitably be used as long as it is water soluble. For example, water soluble radical polymerization initiators, such as persulfates including potassium persulfate, ammonium persulfate, and the like, are preferably used in order to obtain the effects of the present invention.

As the chain transfer agent, generally used chain transfer agents can be used. For example, 2-chloroethanol; mercaptans, such as octyl mercaptan, dodecyl mercaptan, and t-dodecyl mercaptan, or styrene dimmers can be given.

(3) The process of obtaining a dispersion liquid of coloring agent particles obtained by dispersing coloring agent in an aqueous medium

Oil droplet dispersion is performed by means of mechanical energy, and the disperser thereof is not especially limited, but stirring device equipped with a rotor rotating at a high speed (CLEARMIX manufactured by M TECHNIQUE CO., LTD.), an ultrasonic disperser, a mechanical homogenizer, Cavitron, Manton Gaulin, a pressure type homogenizer, and the like can be used.

The coloring agent particles in the dispersion liquid prepared at this process preferably have a median diameter of 10-300 nm on the volumetric basis, more preferably 100-200 nm, and further more preferably 100-150 nm. For example, by adjusting the magnitude of the mechanical energy, the median diameter on the volumetric basis can be controlled within the aforesaid range.

(4) The process of forming toner particles by performing the aggregation and the fusion of resin particles and coloring agent particles by adding a coagulant into an aqueous medium including a dispersion liquid of the resin particles and a dispersion liquid of the coloring agent particles mixed together therein, and by adjusting the temperature thereof.

As the coagulant, for example, alkali metal salts and alkaline earth metal salts can be given. As the alkali metals of these salts, lithium, potassium, sodium, and the like, can be given. Furthermore, as the alkaline earth metals of these salts, magnesium, calcium, strontium, barium, and the like, can be given. Among them, potassium, sodium, magnesium, calcium, barium are especially preferable. As the counterions (negative ions constituting salts) of the alkali metals or the alkaline earth metals, chloride ions, bromide ions, iodide ions, carbonate ions, sulfate ions, and the like, can be given.

When a releasing agent is added, it is also possible to add the dispersion liquid (wax emulsion) of the releasing agent particles into the aqueous medium to salt out and aggregate the resin particles, the coloring agent particles, and the releasing agent particles at this process.

(5) The process of filtrating toner particles from an aqueous medium to remove undesired substances, such as a surface active agent, from the toner particles by washing processing

(6) The process of performing the drying processing of the toner particles subjected to the washing processing

(7) The process of adding an external additive to the toner particles subjected to the drying processing

The median diameter D50 of a toner of the present invention on the volumetric basis is preferably within the range of 3.0-8.0 μm from the point of view of an image quality. The median diameter (D50) on the volumetric basis can be measured and calculated by using, for example, a device configured of “MULTISIZER 3 (manufactured by BECKMAN COULTER, INC.)” and a computer system that installs data processing software “SOFTWARE V3.51” therein and is connected to MULTISIZER 3. Furthermore, the degree of the circularity of the toner of the present invention can be measured with “FPIA-2100” (manufactured by SYSMEX CORPORATION), and the degree of the circularity is preferably within the range of 0.93-0.98 from the point of view of the transferring property of the toner.

### <Developing Agent>

The toner of the present invention can be used as a binary developing agent comprising carriers and a toner, or a non-magnetic mono-component developing agent composed only of a toner.

As the carriers, which are magnetic particles used at the time of using the toner as a binary developing agent, for example, conventionally publicly known materials, such as metals including iron, ferrite, magnetite, and the like; and alloys of these metals and the metals, such as aluminum and lead can be used. Among them, ferrite particles are preferable. Furthermore, as the carriers, coated carriers, which are magnetic particles the surfaces of which are covered by a covering agent, such as a resin, resin-dispersed type carriers, including impalpable powder of a magnetic substance dispersed in a binder resin, and the like may be used. The volume average diameter of the carriers is preferably within the range of 15-100 μm, and more preferably within the range of 25-80

### EXAMPLES

In the following, concrete examples of the present invention will be described, but the scope of the present invention is not limited to the examples.

1. Production of Crystalline Organic Compounds (C-1) to (C-3)<

### <Production of Crystalline Organic Compound (C-1)>

### (Polycarboxylic Acid Monomer)

sebacic acid: 220 parts by mass
fumaric acid: 1.3 parts by mass

### (Polyvalent Alcohol Monomer)

1,4-butanediol: 83 parts by mass

The polycarboxylic acid monomer and the polyvalent alcohol component were stocked in a flask equipped with a stirring device, a nitrogen introducing pipe, a temperature sensor, and a rectifying column, the interior content of which flask was 5 litters. The temperatures of the polycarboxylic acid monomer and the polyvalent alcohol component were raised to 190° C. by spending one hour. Then, after ascertaining that the inside of the reaction system had been agitated uniformly, a catalyst Ti(OBu)₄ (0.003 mass % of the whole quantity of the polycarboxylic acid monomer) was projected.

Furthermore, the temperature was raised from the same temperature to 240° C. by spending six hours while distilling away the produced water, and polymerization was performed by continuing the dehydration condensation reaction for further six hours at 240° C. Thereby, a crystalline polyester resin was produced, and the crystalline organic compound (C-1) was obtained. By the measurement of the molecular weight of the resin of the obtained crystalline organic compound (C-1) with a gel permeation chromatography (GPC) (HLC-8 120 GPC manufactured by TOSOH CORPORATION), it was found that the number average molecular weight was 3200 (converted by the styrene reference material). Furthermore, as the result of the measurement of the heat characteristic of the obtained resin with a differential scanning calorimeter (DSC) (DIAMOND DSC manufactured by PERKINELMER, INC.) (speed of temperature rise: 10° C./min), it was found that the top of a heat absorption peak thereof was 60° C.

### <Production of Crystalline Organic Compounds (C-2) to (C-6), (C-8), and (C-9)>

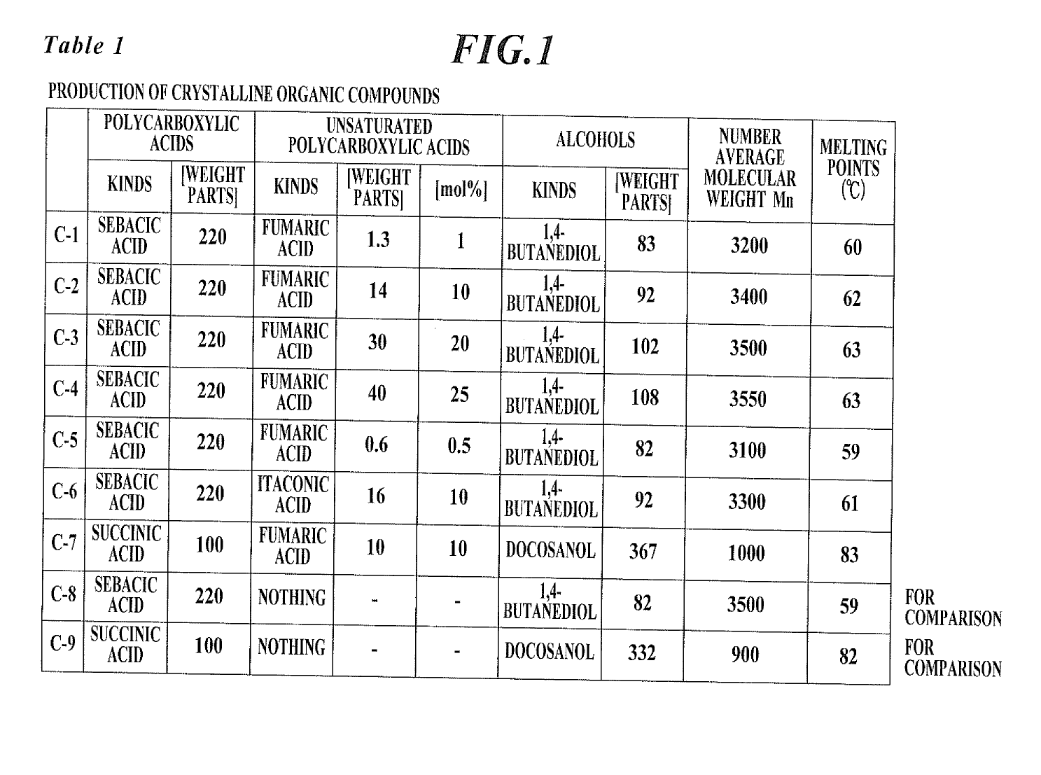

The crystalline organic compounds (C-2) to (C-6), (C-8), and (C-9) were produced similarly to the crystalline organic compound (C-1) except that the polycarboxylic acid monomer and the polyvalent alcohol monomer were changed in accordance with the Table 1 shown in FIG. 1. The number average molecular weights and the melting points were those shown in Table 1.

### <Production of Crystalline Organic Compound (C-7)>

100 parts by mass of succinic acid, 10 parts by mass of fumaric acid, 367 parts by mass of docosanol, and 0.5 parts by mass of methansulfonic acid were added into four flasks, each equipped with a thermometer, a nitrogen introducing pipe, an agitator, and a cooling pipe, and they were reacted for 15 hours in an nitrogen stream while distilling away reaction water at 220° C. After that, sodium hydroxide and hydrogen peroxide were added and filtering was performed. Thereby, a crystalline ester compound was produced, and then the crystalline organic compound (C-7) was synthesized.

2. Preparation of Dispersion Liquids of Crystalline Organic Compounds (C-1) to (C-9)

### <Preparation of Dispersion Liquid of Crystalline Organic Compound (C-1)>

The obtained crystalline organic compound (C-1) was transferred to CAVITRON CD1010 (manufactured by EUROTEC, LTD.) at the speed of 100 parts by mass per minute in its molten state. Diluted aqueous ammonia of the concentration of 0.37 mass % prepared by diluting reagent aqueous ammonia with an ion-exchange water was put into a separately prepared aqueous medium tank, and the dilute aqueous ammonia was transferred to CAVITRON CD1010 (manufactured by EUROTEC, LTD.) at the speed of 0.1 liter per minute while being heated to 90° C. with a heat exchanger at the same time as the transfer of the crystalline organic compound (C-1) in its molten state. CAVITRON CD1010 was driven under the conditions that the rotation speed of the rotor thereof was 60 Hz and the pressure thereof was 5 kg/cm², and the dispersion liquid of the crystalline organic compound (C-1) having the median diameter of 243 nm on the volumetric basis and 30 parts by mass of solid content quantity was obtained.

### <Preparation of Dispersion Liquids of Crystalline Organic Compounds (C-2) to (C-9)>

As for also the crystalline organic compounds (C-2) to (C-9), the dispersion liquids of the crystalline organic compounds (C-2) to (C-9) were obtained by the methods similar to that of the preparation of the dispersion liquid of the crystalline organic compound (C-1).

3. Preparation of Releasing Agent Dispersion Liquid

### <Preparation of Releasing Agent Dispersion Liquid 1>

behenic acid behenate (melting point: 71° C.): 60 parts

ionizable surface active agent (NEOGEN RK manufactured by DAI-ICHI KOGYO SEIYAKU CO., LTD.): 5 parts

ion-exchange water: 240 parts

A solution containing the mixed aforesaid components was heated to 95° C., and the solution was sufficiently dispersed with ULTRA-TURRAX T50 manufactured by IKA COMPANY. After that, the dispersed solution was subjected to dispersion processing with a pressure discharging type GAULIN HOMOGENIZER to obtain the releasing agent dispersion liquid 1 having a volume average diameter of 240 nm and a solid content quantity of 20 mass %.

4. Preparation of Resin Particle Dispersion Liquids 1-10

### <Preparation of Resin Particle Dispersion Liquid 1>

A polymerization initiator solution obtained by dissolving 10.3 parts by mass of potassium persulfate into 210 parts by mass of ion-exchange water was added to 1450 parts by weight of “dispersion liquid of crystalline organic compound (C-1),” obtained by the aforesaid method, 650 parts by weight of “releasing agent dispersion liquid 1,” and 1250 parts by weight of ion-exchange water, and a monomer mixture liquid containing the following compounds was dropped for two hours under the temperature condition of 80° C.

styrene: 300.2 parts by mass
n-butyl acrylate: 113.1 parts by mass
methacrylic acid: 21.8 parts by weight
n-octyl mercaptan: 8.2 parts by mass

After the completion of the dropping, polymerization was performed by agitating the liquid while heating it for two hours. After the completion of the polymerization, the liquid was cooled to 28° C. to produce a “resin particle dispersion liquid 1” comprising the crystalline organic compound particles as nuclei and a vinyl series resin covering the crystalline organic compound particles.

### <Preparation of Resin Particle Dispersion Liquids 2 to 10>

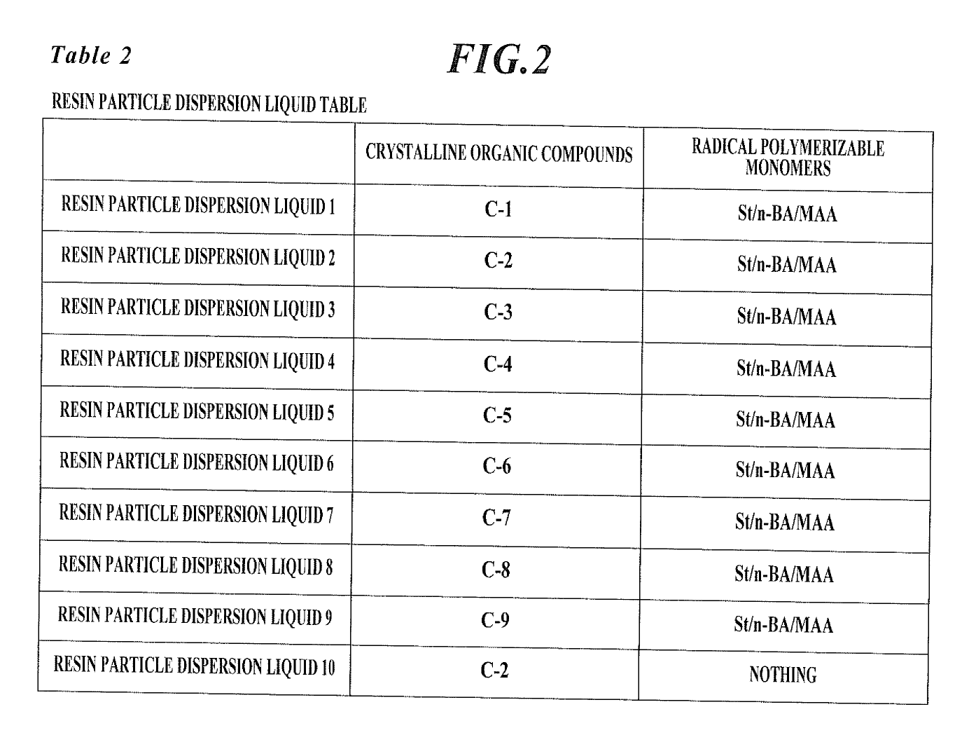

The resin particle dispersion liquids 2 to 9 were produced by the methods similar to that of the resin particle dispersion liquid 1 except that the “dispersion liquid of crystalline organic compound (C-1)” in the preparation of the resin particle dispersion liquid 1 was changed to the “dispersion liquids of crystalline organic compounds (C-2) to (C-9),” respectively, in accordance with Table 2 shown in FIG. 2.

In addition, the resin particle dispersing liquid 10 was produced without adding any radical polymerizable monomers.

5. Preparation of Shell Forming Resin Particles

600 parts by mass of water was stocked in a reaction container, to which a stirring device, a temperature sensor, a cooling pipe, a nitrogen introducing device were attached, and the internal temperature of the reaction container was raised to 70° C. in a nitrogen stream while agitating the water at the speed of 230 rpm. 119 parts by mass of styrene, 33 parts by mass of n-butyl acrylate, 8 parts by mass of methacrylic acid, and 4.5 parts by mass of n-octyl mercaptan were added to the water, and a water solution prepared by dissolving 3 parts by mass of a polymerization initiator (potassium persulfate:KPS) into 40 parts by mass of an ion-exchanging water was added to the former water. This system was heated and agitated for 10 hours at 70° C. to prepare shell forming resin particles.

The weight-average molecular weight (Mw) of the shell forming resin particles was 13200. Furthermore, the number mean particle diameter of the composite resin particles constituting the shell forming resin particles was 221 nm, and the temperature of the glass transition point (Tg) thereof was 55.4° C.

6. Preparation of Coloring Agent Fine Particle Dispersion Liquid

11.5 parts by mass of n-sodium dodecyl sulfate was agitated and dissolved into 160 parts by mass of ion-exchange water, and 25 parts by mass of C.I. pigment blue 15:3 was gradually added thereto. Next, the C.I. pigment blue 15:3 was dispersed with “CLEARMIX W-MOTION CLM-0.8” (manufactured by M TECHNIQUE CO., LTD.) to obtain the coloring agent fine particle dispersion liquid 1 containing coloring agent fine particles 1 having the median diameter of 158 nm on the volumetric basis.

In addition, the median diameter on the volumetric basis was measured under the following measurement conditions with “MICROTRAC UPA 150” (manufactured by HONEYWELL INTERNATIONAL INC.).

### [Measurement Conditions]

sample refraction index: 1.59

sample specific gravity: 1.05 (converted by the sphere-shaped particle)

solvent refraction index: 1.33

solvent viscosity: 0.797 at 30° C. and 1.002 at 20° C.

The ion-exchange water was put into a measurement cell, and the zero point adjustment thereof was performed.

7. Manufacturing of Toners 1-10

### <Manufacturing of Toner 1>

400 parts by mass (converted by the solid content) of “resin particle dispersion liquid 1,” as a resin for cores, 1500 parts by mass of ion-exchange water, and 165 parts by mass of “coloring agent particle dispersion liquid 1” were projected into a separable flask equipped with a thermometer, a cooling pipe, a nitrogen introducing device, and an agitating device. Furthermore, aqueous sodium hydroxide (25 mass %) was added in the state of keeping the temperature in the system at 30° C. to adjust the hydrogen ion exponent (pH) thereof to be 10.

Next, an aqueous solution in which 54.3 parts by mass of magnesium chloride.6 hydrate was dissolved in 54.3 parts by mass of an ion-exchange water was added, and after that, the temperature in the system was raised to 60° C. to start the agglutination reactions of the resin particles and the coloring agent particles.

After the start of the agglutination reactions, sampling was periodically performed, and the median diameter (D₅₀) on the volumetric basis of the sample particles was measured with a particle size distribution measuring device “COULTER MULTISIZER 3” (manufactured by BECKMAN COULTER, INC.). When the measured median diameter on the volumetric basis became 5.8 μm, 200 parts by mass of the “shell forming resin particles” was added as a shell material.

Furthermore, an aqueous solution in which 2 parts by mass of the magnesium chloride.6 hydrate was dissolved in 2 parts by mass of the ion-exchange water was added for 10 minutes. Agitation was continued until the median diameter (D₅₀) of the particles on the volumetric basis became 6 μm.

When the degrees of circularity of the toner particles were measured with a flow type particle image analyzing device “FPIA-2100” (manufactured by SYSMEX CORPORATION), it was found that the degree of circularity of the toner particles at this time point was 0.951. The agitation was continued for four hours with the temperature kept at 65° C., and the toner particle dispersion liquid was cooled to 30° C. under the condition of 6° C./min when the degree of circularity of the toner particles reached 0.976 to complete the reactions.

Next, the solid-liquid separation of the produced toner particle dispersion liquid was subjected to a basket type centrifugal separator “MARK III TYPE” (MODEL NUMBER 60×40) (manufactured by MATSUMOTO KIKAI MFG. CO., LTD.) to form a wet cake of the toner. After that, the washing and the solid-liquid separation of the toner were repeated until the value of the electric conductivity of the filtrate became 15 μS/cm or less.

Next, the wet cake was moved to an airflow type dryer “FLASH JET DRYER” (manufactured by SEISHIN ENTERPRISE CO., LTD.), and the drying processing of the wet cake was performed until the water quantity thereof became 0.5 mass %. In addition, the drying processing was performed by blowing the airflow of 40° C. and 20% RH against the water cake. The dried toner was slowly cooled to 24° C., and 1.0 part by mass of hydrophobic silica was mixed to 100 parts by mass of toner with HENSCHEL MIXER. After setting the peripheral speed of the rotor blade to 24 m/s and mixing the mixture for 20 minutes, the mixture was made to pass through a sieve of 400 meshes. The thus obtained toner is referred to as the “toner 1.”

When a cross sectional layer of the obtained “toner 1” was observed with a transmission electron microscope LEM-2000 TYPE (made by TOPCON CORPORATION), it was found that the cross sectional layer had the structure in which the crystalline organic compounds and the releasing agents were dispersed in the vinyl series resin. The exposure of the crystalline organic compounds to the toner surfaces did not exist, and the crystalline organic compounds were especially uniformly dispersed.

### <Manufacturing of Toners 2-10>

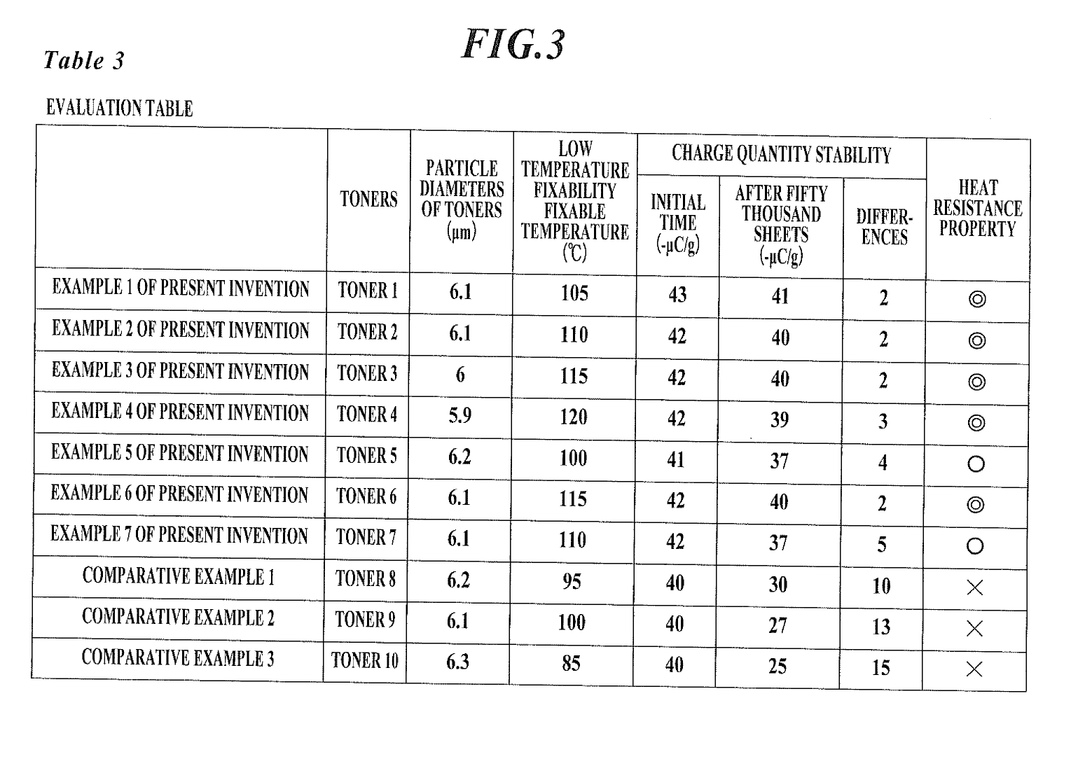

As shown in Table 3 of FIG. 3, the toners 2-10 were produced by the methods similar to that of the toner 1 except that the “resin particle dispersion liquid 1” in the manufacturing of the toner 1 was changed to “resin particle dispersion liquids 2-10,” respectively.

8. Preparation of Developing Agents

Ferrite carriers covered by a silicone resin and having a volume average particle diameter of 60 nm were mixed to each of the produced toners 1-10 to prepare the developing agent of each of the toners 1-10. The ferrite carriers were mixed to each toner so that the concentration of the toner in each developing agent became 6 mass %.

9. Evaluation Experiments

The developing agent of each of the toners 1-10 was mounted on a commercially available multifunction peripheral “BIZHUB PRO C500” (manufactured by KONICA MINOLTA BUSINESS TECHNOLOGIES, INC.). Then, the evaluation tests of the following respective items were performed, and the results are shown in Table 3. Furthermore, the particle diameter of each of the toners 1-10 is also shown in Table 3.

### <Low Temperature Fixability>

Commercially available digital copier “BIZHUB PRO C500” (manufactured by KONICA MINOLTA BUSINESS TECHNOLOGIES, INC.) was used. The setting thereof was changed in order that the surface temperature of a fixation heating member may change by 5° C. within the range of 80-150° C. At each temperature, photoprint matter was obtained by performing the fixation processing of a toner image by using 350 g of paper, weighed in the environment of an ordinary temperature (temperature: 20° C., humidity: 50% RH), as an image supporting body. The fixation strength of the image part of the photoprint matter was measured by the following mending tape peeling method, and the minimum temperature of the fixation heating member capable of obtaining 90% or more of the fixation strength thereof was evaluated as the fixable temperature. In addition, the developing agents having the fixable temperatures of 120° C. or less were judged to be acceptable.

### <Charge Quantity Stability>

Charge quantities at the initial time and after the completion of printing fifty thousand sheets were measured. The evaluations of the charge quantities were performed on the basis of the differences between those at the initial time and those after the completion of printing fifty thousand sheets. In addition, the charge quantities were values obtained by the following blow-off method.

The measurements of the charge quantities by the blow-off method were performed with a blow-off charge quantity measuring device “TB-200 (manufactured by TOSHIBA CHEMICAL CORPORATION).” A two-component developing agent to be measured was set in the charge quantity measuring device, installing a stainless steel screen having 400 meshes, and blew a nitrogen gas to the two-component developing agent for 10 seconds under the condition of the blow pressure of 50 kPa. Electric charges were thus measured. By dividing the measured charges by flown toner mass, the charge quantities (μC/g) were calculated.

If the differences between the charge quantities of the initial time and those after the completion of printing fifty thousand sheets are 5 μC/g or less, the differences are at the levels of causing no problems.

### <Blocking Resistance (Heat Storage Resistance)>

0.5 g of a toner was taken out into a glass bottle of 10 ml having an inner diameter of 21 mm, and the lid of the glass bottle was closed. Then, the glass bottle was shaken by 600 times at a room temperature with TAP DENSER KYT-2000 (manufactured by SEISHIN ENTERPRISE CO., LTD.), then, after that, the glass bottle was left in the environment of 55° C. and 35% RH for two hours with the lid thereof taken off. Next, the toner was placed on a sieve of 48 meshes (apertures: 350 μm) with the caution of preventing the shredding of the aggregate of the toner, and was set in POWDER TESTER (manufactured by HOSOKAWA MICRON CORPORATION). The sieve was fixed with a pressing bar and a knob nut, and the vibration magnitude of the sieve was adjusted to be that of the sending width of 1 mm. Then, the sieve was vibrated for 10 seconds, and, after that, the ratio (mass %) of the toner quantity remaining on the sieve was measured. The aggregation rate of the toner is the value calculated by the following formula.

(aggregation rate of toner (%))=(mass of toner remaining on sieve (g))/0.5 (g)×100

The heat storage resistances of toners were evaluated on the basis of the criteria described below.

“⊚”: aggregation rate of toner is less than 15 mass % (heat storage resistance of toner is extremely good)

“∘”: aggregation rate of toner is 20 mass % or less (heat storage resistance of toner is good)

“x”: aggregation rate of toner exceeds 20 mass % (heat storage resistance of toner is bad and toner is unusable)

As apparent from the results of Table 3, the examples of the present invention can be considered that all of the respects of the low temperature fixability, the charge quantity stability, and the heat storage resistance are superior to those of the comparative examples.

According to a preferred embodiment of the present invention, there is provided a manufacturing method of a toner including a vinyl series resin being a polymer of a radical polymerizable monomer, and a coloring agent, the method comprising:

dispersing a crystalline organic compound having an unsaturated bond in an aqueous medium to prepare a dispersion liquid of the crystalline organic compound;

causing a radical polymerization reaction between an unsaturated bond part of the crystalline organic compound and the radical polymerizable monomer after adding the radical polymerizable monomer to the dispersion liquid of the crystalline organic compound, to prepare a dispersion liquid of resin particles including the obtained polymer; and

mixing at least the dispersion liquid of the resin particles and a dispersion liquid of coloring agent particles, and aggregating the resin particles and the coloring agent particles to form toner particles.

Preferably, the crystalline organic compound having the unsaturated bond is a compound selected from a group comprising a crystalline polyester resin and a crystalline ester compound.

Preferably, the crystalline organic compound having the unsaturated bond is a crystalline polyester resin.

Preferably, a melting point of the crystalline organic compound having the unsaturated bond is within a range of 40° C. to 100° C.

Preferably, a number average molecular weight of the crystalline organic compound having the unsaturated bond is within a range of 500 to 10000.

Preferably, an unsaturated polycarboxylic acid used for a condensation polymerization reaction of the crystalline polyester resin is an acid selected from a group comprising fumaric acid, maleic acid, itaconic acid, mesaconic acid, citraconic acid, and glutaconic acid.

Preferably, an unsaturated polycarboxylic acid used for a condensation polymerization reaction of the crystalline polyester resin is an acid selected from a group comprising fumaric acid, maleic acid, and itaconic acid.

Preferably, a quantity of the unsaturated polycarboxylic acid is within a range of 1 mol to 20 mol % of a whole quantity of a polycarboxylic acid used for producing a polyester resin.

Preferably, the radical polymerizable monomer is added by a mass ratio of 5% to 70% crystalline organic compound.

Preferably, the radical polymerization reaction advances by adding a water soluble polymerization initiator.

Preferably, the preparing of the dispersion liquid of the resin particles further comprises adding a dispersion liquid of releasing agent particles to perform the radical polymerization reaction.

Preferably, the forming of the toner particles further comprises adding a dispersion liquid of releasing agent particles to perform the aggregating.

According to a preferred embodiment of the present invention, there is provided a toner including a vinyl series resin being a polymer of a radical polymerizable monomer, and a coloring agent, comprising:

a crystalline organic compound, the crystalline organic compound having an unsaturated bond, wherein

a radical polymerization reaction is caused between an unsaturated bond part of the crystalline organic compound and the radical polymerizable monomer.

According to the present invention, polymerization is caused between an unsaturated part of a crystalline organic compound and a radical polymerizable monomer by making the radical polymerizable monomer perform a radical polymerization reaction with a dispersion liquid of the crystalline organic compound including an unsaturated bond, and the crystalline organic compound and a polymer (vinyl series resin) of the radical polymerizable monomer are complexed with a chemical reaction caused at an interface between them.

Because the surfaces of the particles of the crystalline organic compound are, hereby, complexed in a state where a chemical bond part with the polymer of the radical polymerizable monomer exists, the particles of the crystalline organic compound are uniformly dispersed and arranged in the vinyl series resin, which is the main resin of a toner, in an incompatible state in spite of disturbances, such as heating, in the process of aggregating particles to produce a toner. Consequently, it can be considered that the sharply melting property of the toner at the time of the fixation thereof becomes good to improve the low temperature fixability. Furthermore, because the crystalline organic compound particles are led to be covered by the vinyl series resin in the state of having chemical bonds, the toner particles are formed without crystalline organic compound being exposed on the surfaces of the toner particles also at the time of producing the toner from the composite resin particles. Consequently, it can be considered that the improvement of the blocking resistance and the stabilization of the charge quantity can thereby be obtained.

Although various exemplary embodiments have been shown and described, the invention is not limited to the embodiments shown. Therefore, the scope of the invention is intended to be limited solely by the scope of the claims that follow.

What is claimed is:

1. A manufacturing method of a toner including a vinyl series resin being a polymer of a radical polymerizable monomer, and a coloring agent, the method comprising:
dispersing a crystalline organic compound having an unsaturated bond in an aqueous medium to prepare a dispersion liquid of the crystalline organic compound;
causing a radical polymerization reaction between an unsaturated bond part of the crystalline organic compound and the radical polymerizable monomer after adding the radical polymerizable monomer to the dispersion liquid of the crystalline organic compound, to prepare a dispersion liquid of resin particles including the obtained polymer; and
mixing at least the dispersion liquid of the resin particles and a dispersion liquid of coloring agent particles, and aggregating the resin particles and the coloring agent particles to form toner particles.

2. The manufacturing method of the toner as claimed in claim 1, wherein the crystalline organic compound having the unsaturated bond is a compound selected from a group comprising a crystalline polyester resin and a crystalline ester compound.

3. The manufacturing method of the toner as claimed in claim 1, wherein the crystalline organic compound having the unsaturated bond is a crystalline polyester resin.

4. The manufacturing method of the toner as claimed in claim 1, wherein a melting point of the crystalline organic compound having the unsaturated bond is within a range of 40° C. to 100° C.

5. The manufacturing method of the toner as claimed in claim 1, wherein a number average molecular weight of the crystalline organic compound having the unsaturated bond is within a range of 500 to 10000.

6. The manufacturing method of the toner as claimed in claim 3, wherein an unsaturated polycarboxylic acid used for a condensation polymerization reaction of the crystalline polyester resin is an acid selected from a group comprising fumaric acid, maleic acid, itaconic acid, mesaconic acid, citraconic acid, and glutaconic acid.

7. The manufacturing method of the toner as claimed in claim 3, wherein an unsaturated polycarboxylic acid used for a condensation polymerization reaction of the crystalline polyester resin is an acid selected from a group comprising fumaric acid, maleic acid, and itaconic acid.

8. The manufacturing method of the toner as claimed in claim 6, wherein a quantity of the unsaturated polycarboxylic acid is within a range of 1 mol % to 20 mol % of a whole quantity of a polycarboxylic acid used for producing a polyester resin.

9. The manufacturing method of the toner as claimed in claim 1, wherein the radical polymerizable monomer is added by a mass ratio of 5% to 70% of the crystalline organic compound.

10. The manufacturing method of the toner as claimed in claim 1, wherein the radical polymerization reaction advances by adding a water soluble polymerization initiator.

11. The manufacturing method of the toner as claimed in claim 1, wherein the preparing of the dispersion liquid of the resin particles further comprises adding a dispersion liquid of releasing agent particles to perform the radical polymerization reaction.

12. The manufacturing method of the toner as claimed in claim 1, wherein the forming of the toner particles further comprises adding a dispersion liquid of releasing agent particles to perform the aggregating.

13. A toner including a vinyl series resin being a polymer of a radical polymerizable monomer, and a coloring agent, comprising:
a crystalline organic compound, the crystalline organic compound having an unsaturated bond, wherein
a radical polymerization reaction is caused between an unsaturated bond part of the crystalline organic compound and the radical polymerizable monomer.
